(19) United States
(12) Patent Application Publication
(10) Pub. No.: US 2008/0048953 A1
(43) Pub. Date: Feb. 28, 2008

(54) DISPLAY APPARATUS AND METHOD THEREOF

(75) Inventors: Byung-Sik KOH, Gwangmyeong-si (KR); Chun-Seok KO, Hwaseong-si (KR); Si-Duk SUNG, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD.,, Suwon-si (KR)

(21) Appl. No.: 11/833,308

(22) Filed: Aug. 3, 2007

(30) Foreign Application Priority Data
Aug. 3, 2006 (KR) 2006-73192

(51) Int. Cl. G09G 3/32

(52) U.S. Cl. 345/82

(57) ABSTRACT

A display panel includes a display area and a peripheral area, and a power applying terminal portion is formed on the peripheral area. The frame includes a cover portion covering an edge of the display panel, and a power connecting terminal portion formed on an inner surface of the cover portion and electrically connected to the power applying terminal portion. The power supply part is disposed on the frame and supplies a driving power to the power connecting terminal portion.

This application claims priority to Korean Patent Application No. 2006-73192, filed on Aug. 3, 2006, and all the benefits accruing therefrom under 35 U.S.C. §119, the contents of which are herein incorporated by reference in its entirety.

### BACKGROUND OF THE INVENTION

1. Field of the Invention

The present invention relates to a display apparatus. More particularly, the present invention relates to a display apparatus capable of decreasing costs for manufacturing.

2. Description of the Related Art

An organic light-emitting display apparatus displaying images using an organic light-emitting diode (“OLED”) has been widely used among various kinds of display apparatuses, since the organic light-emitting display apparatus has various characteristics such as thin thickness, low driving voltage, low power consumption, a simple structure, etc.

The OLED includes first and second electrodes, which are formed on an insulating substrate and to which a driving voltage is applied, and a light-emitting layer formed between the first and second electrodes, for displaying the images.

As a size of the OLED increases, a capacity of the driving voltage increases, so that an electric current flowing between the first and second electrodes increases as well.

Therefore, in order to solve the above problem, the driving voltage is applied to four sides of the insulating substrate. For example, printed circuit boards (“PCBs”) are respectively disposed at the four sides of the insulating substrate, and then the driving voltage is applied to the first and second electrodes.

However, the PCBs disposed at the four sides make the organic light display apparatus have a complicated structure, and increases costs for manufacturing the organic light display apparatus.

### BRIEF SUMMARY OF THE INVENTION

An exemplary embodiment provides a display apparatus decreasing costs for manufacturing.

In an exemplary embodiment of display apparatus, the display apparatus includes a display panel, a frame and a power supply part. The display panel includes a display area and a peripheral area. A power apply terminal portion is disposed in the peripheral area. The frame includes a cover portion covering an edge of the display panel, and a power connecting terminal portion disposed on an inner surface of the cover portion and electrically connected to the power applying terminal portion. The power supply part is disposed on the frame and supplies a driving power to the power connecting terminal portion.

In an exemplary embodiment, the cover portion may include an insulation material.

In an exemplary embodiment, the plurality of pixel portions may be disposed in the display area of the display panel. Each pixel portion includes a first switching element electrically connected to a gate line and a data line, a second switching element electrically connected to the first switching element, a driving electrode, and an organic emitting element electrically connected to the second switching element and a common electrode.

In an exemplary embodiment, the power applying terminal portion may include a common voltage applying terminal disposed at a first edge portion of an insulating substrate of the display panel and applying a common voltage of the driving power to the common electrode, and a driving voltage applying terminal disposed at a second edge portion of the display panel perpendicular to the first edge portion and applying a driving voltage of the driving power to the driving electrode.

In an exemplary embodiment, the power connecting terminal portion may include a first combination portion combined with the cover portion, a second combination portion extended from a first end of the first combination portion towards the peripheral area of the display panel, and electrically combined with the power applying terminal portion, and a third combination portion extended from the cover portion corresponding to a second end of the first combination portion and fixing the display panel like the second combination portion.

In an exemplary embodiment, a distance in a first direction between the second and third combination portions may be shorter than a thickness in the first direction of the display panel including the power applying terminal portion by about 0.02 millimeter (mm) to about 0.08 millimeter (mm). The second combination portion may have a trapezoidal shape.

In an exemplary embodiment, the second combination portion may include a protrusion portion disposed at a distal end portion of the second combination portion, protruding towards the third combination portion and contacting the power applying terminal portion. The protrusion portion may have a rounded shape. The protrusion portion may have a triangular shape.

In an exemplary embodiment, the power connecting terminal portion may include a common voltage connecting terminal combined with the common voltage applying terminal, and a driving voltage connecting terminal combined with the driving voltage applying terminal.

In an exemplary embodiment, the frame may include a first side portion, on which the common voltage connecting terminal is disposed, a second side portion adjacent to and perpendicular to the first side portion, on which the driving voltage connecting terminal disposed, a third side portion facing the first side portion and being removably connected to the second side portion, and a fourth side portion facing the second side portion and being removably connected to the third side portion.

In an exemplary embodiment, the display panel may further include a gate printed circuit part corresponding to the third side portion of the frame and connected to a third edge portion of the insulating substrate that faces the first edge portion of the insulating substrate, a data printed circuit part corresponding to the fourth side portion of the frame and connected to a fourth edge portion of the insulating substrate that faces the second edge portion of the insulating substrate, and a control part disposed in the display area of the display panel connected to the gate printed circuit part and the data printed circuit part.

In an exemplary embodiment, the first and second side portions of the frame are configured to be separated from the third and fourth side portions of the frame. The frame may include a penetration groove in the third and fourth side portions, and the display panel passes through the penetrating groove and is combined with the power connecting terminal portion.

In an exemplary embodiment, the power supply part corresponds to a corner of the frame where the first and second side portions of the frame are adjacent to each other.

An exemplary embodiment of a method of forming a display apparatus includes forming a display panel including a display area and a peripheral area, disposing a power applying terminal portion on the peripheral area of the display panel, forming a frame including a cover portion and a power connecting terminal portion disposed on an inner surface of the cover, disposing a power supply part on the frame and supplying a driving power to the power connecting terminal portion; and combining the display panel and the frame, electrically connecting the power applying terminal portion on the display panel and the power connecting terminal portion of the frame, and the cover covering an outer edge of the display panel

An exemplary embodiment provides the driving power supplied to the driving electrode and the common electrode through the power connecting terminal portion disposed on the inner surface of the cover portion, so that two printed circuit boards (“PCBs”) may be eliminated. Advantageously, a structure of the display panel may be simplified and the costs for manufacturing the display panel may be decreased.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view illustrating an exemplary embodiment of a display apparatus according to the present invention;

FIG. 2 is a plan view illustrating the display panel in FIG. 1;

FIG. 3 is a cross-sectional view taken along line I-I′ in FIG. 2;

FIG. 4 is a plan view illustrating an exemplary embodiment of a rear surface of the combined display apparatus in FIG. 1;

FIG. 5 is a schematic circuit diagram illustrating an exemplary embodiment of a pixel portion of the display panel in FIG. 2;

FIG. 6 is an enlarged perspective view illustrating an exemplary embodiment of a portion of the display panel and the frame in FIG. 1;

FIG. 7 is a cross-sectional view of an exemplary embodiment of a display apparatus, which includes a power connecting terminal portion according to the present invention, taken along line II-II′ in FIG. 6;

FIG. 8 is a cross-sectional view illustrating a combination of the display panel and the frame in FIG. 7;

FIG. 9 is a cross-sectional view of another exemplary embodiment of a display apparatus, which includes a power connecting terminal portion according to the present invention, taken along the line II-II′ in FIG. 6;

FIG. 10 is a cross-sectional view of another exemplary embodiment of a display apparatus, which includes a power connecting terminal portion according to the present invention, taken along the line II-II′ in FIG. 6;

FIG. 11 is a perspective view illustrating another exemplary embodiment of a display apparatus according to the present invention;

FIG. 12 is a plan view illustrating an exemplary embodiment of a combination of the display apparatus and the frame in FIG. 11; and

FIG. 13 is a perspective view illustrating another exemplary embodiment of a display apparatus according to the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” the other elements or features. Thus, the term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region disposed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

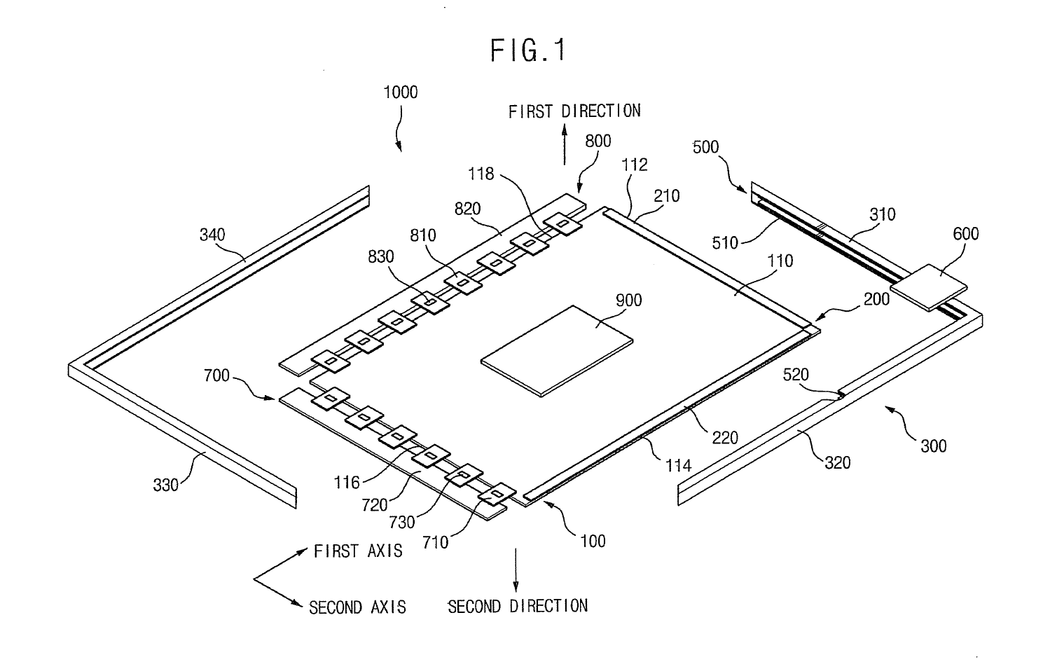

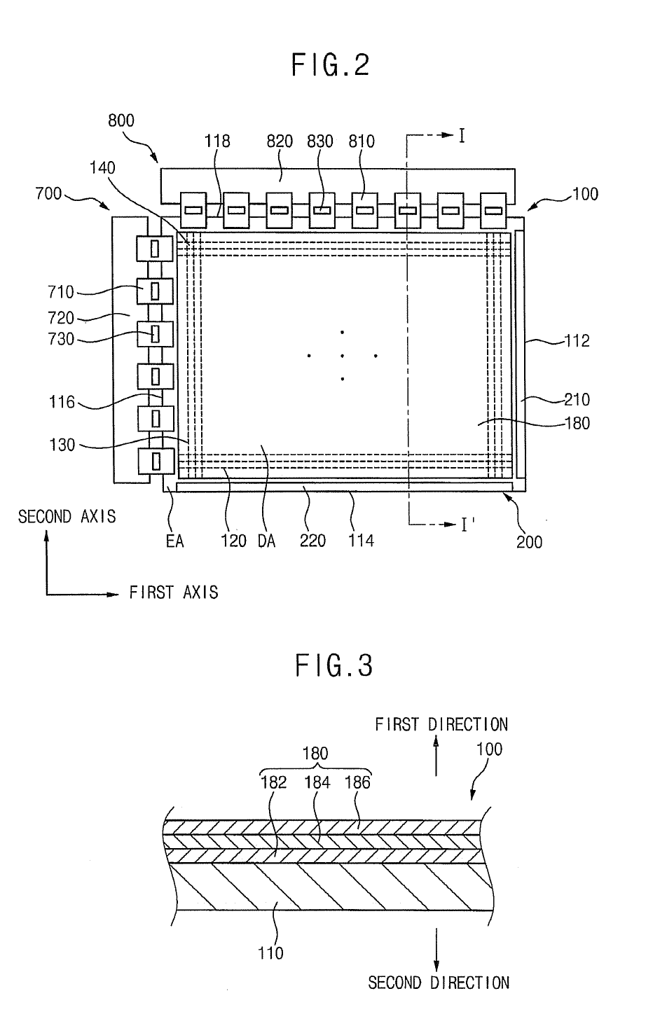

FIG. 1 is an exploded perspective view illustrating an exemplary embodiment of a display apparatus according to the present invention. FIG. 2 is a plan view illustrating the display panel in FIG. 1, and FIG. 3 is a cross-sectional view taken along line I-I′ in FIG. 2.

Referring to FIGS. 1 and 2, the display apparatus 1000 includes a display panel 100, a frame 300 and a power supply part 600.

The display panel 100 includes a display area DA displaying images, and a peripheral area EA formed around the display area DA. A power applying terminal portion 200 is formed on the peripheral area EA of the display panel 100.

The display panel 100 includes an insulating substrate 110, and an organic light-emitting element 180 formed on the insulating substrate 110. As in the illustrated embodiment, the organic light-emitting element 180 is formed on the insulating substrate 1 00 along a first direction, but the present invention is not limited thereto.

In an exemplary embodiment, the insulating substrate 110 includes a transparent material, such as glass, for transmitting light. A plurality of gate lines 120 and a plurality of date lines 130 substantially perpendicular to each other are formed on the insulating substrate 110. As in the illustrated embodiment, the gate lines 120 are formed along a first axis, and the data lines 130 are formed along a second axis.

A plurality of pixel portions 140 is defined by the gate lines 120 and the data lines 130 on the insulating substrate 110, such as at intersections of the gate lines 120 and the data lines 130. The pixel portions 140 are formed in the display area DA of the display panel 100, such that light for displaying the images passes through the pixel portions 140.

The organic light-emitting element 180 includes a first electrode 182, a second electrode 186 and a light-emitting layer 184 formed between the first and second electrodes 182 and 186. A driving voltage is applied to the first electrode 182 from the power applying terminal portion 200 through a thin film transistor (“TFT”). In exemplary embodiments, materials that may be used for the first electrode 182 may include, but are not limited to, a transparent conductive material such as indium tin oxide (ITO) and indium zinc oxide (IZO).

In an exemplary embodiment, the light-emitting layer 184 may include a red light-emitting area emitting red light, a green light-emitting area emitting green light and a blue light-emitting area emitting blue light. The red, greed and blue light-emitting areas are formed to sequentially correspond to the pixel portions 140. Therefore, desired color images may be displayed by the display panel 100.

Alternatively, the light-emitting layer 184 may include only a white light-emitting area emitting white light. In this case, an additional color filter substrate (not shown) may be formed on the white light-emitting area of the light emitting layer 184.

Red, green and blue color filters are formed on the color filter substrate, to have a thin film shape and to correspond to the pixel portions 140. Thus, the desired color image may be displayed through the color filters even though the light-emitting layer 184 has only the white light-emitting area, additionally when the light-emitting layer 184 includes the red, green and blue light-emitting areas.

The second electrode 186 is formed on the entire display area DA. A common voltage is directly applied to the second electrode 186 through the power applying terminal portion 200. When an electric field is generated between the first and second electrodes 182 and 186, an electric current may flow in the light-emitting layer 184. The second electrode 186 may include an opaque material. In an exemplary embodiment, a material that may be used for the second electrode 186 may include aluminum that has relatively good light reflectivity and electric conductivity.

As in the illustrated embodiment, the first electrode 182 includes the transparent material, and the second electrode 186 includes the opaque material, such that the light emitted by the light-emitting layer 184 exits toward a second direction opposite to the first direction, e.g., in a direction of the transparent material. Alternatively, the first electrode 182 may include the opaque material, and the second electrode 186 may include the transparent material, so that the light emitted by the light-emitting layer 184 may exit toward the first direction.

The power applying terminal portion 200 formed on the display panel 100 includes a common voltage applying terminal 210 and a driving voltage applying terminal 220. The common voltage applying terminal 210 is formed at a first edge portion 112 of the insulating substrate 110 and applies a common voltage to the second electrode 186. The driving voltage applying terminal 220 is formed at a second edge portion 114 substantially perpendicular to the first edge portion 112 and applies a driving voltage to the first electrode 182.

In the illustrated embodiment, adjacent ends of the common voltage applying terminal 210 and the driving voltage applying terminal 220 are spaced apart from each other and from edges of the second and first edge portions 114 and 112, respectively. The common voltage applying terminal 210 and the driving voltage applying terminal 220 are illustrated as separate parts, however the invention is not limited thereto. Alternatively, the common voltage applying terminal 210 and the driving voltage applying terminal 220 may be formed in a single (e.g., integral) member, such as in an L-shape. The common voltage applying terminal 210 and/or the driving voltage applying terminal 220 may also include multiple parts forming the common voltage applying terminal 210 and the driving voltage applying terminal 220.

The common voltage applying terminal 210 and the driving voltage applying terminal 220 are shown as substantially planar bar-shaped parts, including a rectilinear cross-section taken perpendicular to a longitudinal direction of the common voltage applying terminal 210 and the driving voltage applying terminal 220. Alternatively, any of a number of shapes and/or cross sections of the common voltage applying terminal 210 and/or the driving voltage applying terminal 220 may be used as is suitable for the purpose described herein.

Since the first electrode 182 is formed to correspond to each pixel portion 140, relatively higher resistance occurs when the driving voltage is applied to the first electrode 182. Therefore, the common voltage applying terminal 210 is formed along the second axis corresponding to a short side (e.g., in a transverse direction) of the display panel 100, and the driving voltage applying terminal 220 is formed along the first axis perpendicular to the second axis and corresponding to a long side (e.g., in a longitudinal direction) of the display panel 100. Alternatively, the common voltage applying terminal 210 may be formed along the first axis, and the driving voltage applying terminal 220 may be formed along the second axis.

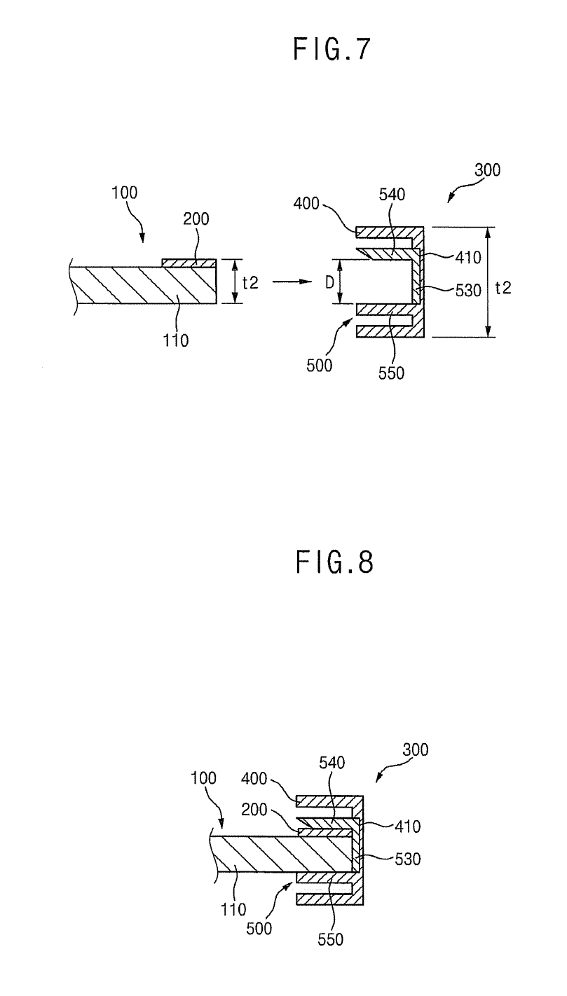

The frame 300 includes a cover portion 400 (FIG. 7) covering an edge (e.g., peripheral and outer edges) of the display panel 100, and a power connecting terminal portion 500 formed on an inner surface of the cover portion 400. In one exemplary embodiment, a cross-sectional shape of the cover portion 400 has a substantially U-shape. The cover portion 400 includes an insulating material, for electrically insulating the display panel 100. An exemplary embodiment of a material that may be used for the cover portion 400 may include poly carbonate (PC) that has relatively good strength.

The power connecting terminal portion 500 is electrically combined with the power applying terminal portion 200 applying the driving and common voltages to the first and second electrodes 182 and 186, respectively. The power connecting terminal portion 500 includes a common voltage connecting terminal 510 combined with the common voltage applying terminal 210 of the power applying terminal portion 200, and a driving voltage connecting terminal 520 combined with the driving voltage applying terminal 220 of the power applying terminal portion 200. In exemplary embodiments, the power connecting terminal portion 500 may have substantially the same U-shape as the cover portion 400 and/or may be connected to the power applying terminal portion 200.

The frame 300 includes a first side portion 310, a second side portion 320 perpendicular to the first side portion 310, a third side portion 330 facing the first side portion 310, and a fourth side portion 340 facing the second side portion 320. The common voltage connecting terminal 510 is formed on the first side portion 310 of the frame 300. The driving voltage connecting terminal 520 is formed on the second side portion 320 of the frame 300. The third side portion 330 is vertically connected to the second side portion 320. The fourth side portion 340 is vertically connected to the first side portion 310. Advantageously, the first and second side portions 310 and 320 may be separated from the third and fourth side portions 330 and 340, respectively, for covering the display panel 100. As used herein, “vertically connected” is used to indicate that ends of the respective side portions are configured to be removably combined with each other. The power supply part 600 is disposed on the cover portion 400 of the frame 300 and supplies a driving power such as the driving and common voltages to the power connecting terminal portion 500. In an exemplary embodiment, the power supply part 600 converts an external alternating current (AC) voltage into a direct current (DC) voltage, and applies the DC voltage to the first and second electrodes 182 and 186 of the organic light emitting element 180.

The power supply part 600 is directly connected to the common voltage connecting terminal 510 formed on the first side portion 310 of the frame 300, and the driving voltage connecting terminal 520 formed on the second side portion 320 of the frame 300. As in the illustrated embodiment, one power supply part 600 is disposed to correspond to an edge at which the first and second side portions 310 and 320 are adjacent to each other. The power supply part 600 is disposed at a corner of the frame 300 overlapping both the first and second side portions 310 and 320.

Alternatively, a power supply parts 600 having a substantially smaller size may be disposed on each of the first side portion 310 and on the second side portion 320, respectively. Advantageously, an electrical connection to the first electrode 182 and the electrical connection to the second electrode 186 may be separately controlled, such that when one of the electrical connections to the first and second electrodes 182 and 186 of the display panel 100 is out of order, damaged or needs repair, the defective electrical connections may be relatively easily repaired and exchanged.

As in the illustrated embodiment, the display apparatus 1000 supplies the driving voltage and the common voltage to the first electrode 182 and the second electrode 186 through the power connecting terminal portion 500 formed on the inner surface of the cover portion 400 of the frame 300, so that manufacturing costs may be decreased.

In addition, the structure of the display apparatus 1000 may be further simplified, and the number of processes and/or parts for manufacturing the display apparatus 1000 may be further decreased.

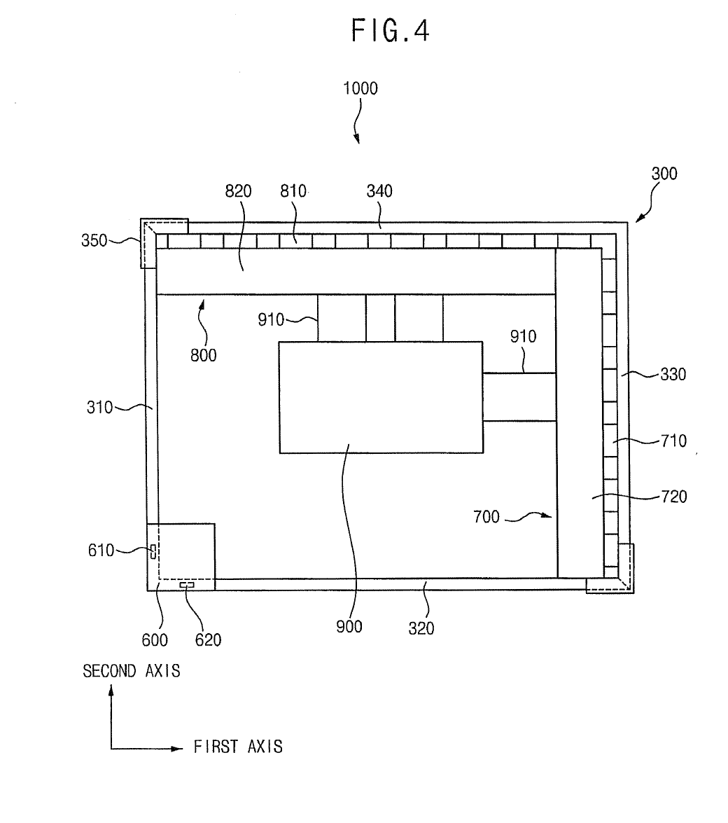

FIG. 4 is a plan view illustrating an exemplary embodiment of a rear surface of the combined display apparatus in FIG. 1.

Referring to FIGS. 1, 2 and 4, the display apparatus 1000 includes a gate printed circuit part 700, a data printed circuit part 800 and a control part 900.

The gate printed circuit part 700 is formed to correspond to the third side portion 330 of the frame 300. As in the illustrated exemplary embodiment, the gate printed circuit part 700 is formed along the second axis and perpendicular to the gate lines 120, for applying the gate voltage to the gate lines 120.

The gate printed circuit part 700 includes a gate flexible circuit film 710, a gate printed circuit board (PCB) 720 and a gate driving chip 730. A first edge of the gate flexible circuit film 710 is connected to a third edge portion 116 opposite to the first edge portion 112 of the insulating substrate 110. A second edge of the gate flexible circuit film 710 opposite to the first edge is connected to the gate PCB 720. The gate driving chip 730 is disposed on the gate flexible circuit film 710 and controls the gate voltage. The third side portion 330 of the frame 300 covers the first edge of the gate flexible circuit film 710 when the display apparatus 1000 is assembled.

The data printed circuit part 800 is formed to correspond to the fourth side portion 340 of the frame 300. As in the exemplary embodiment, the data printed circuit part 800 is formed along the first axis and perpendicular to the data lines 130, for applying the data voltage to the date lines 130.

The data printed circuit part 800 includes a data flexible circuit film 810, a data PCB 820 and a data driving chip 830. A first edge of the data flexible circuit film 810 is connected to a fourth edge portion 118 opposite to the second edge portion 114 of the insulating substrate 110. A second edge of the data flexible circuit film 810 opposite to the first edge is connected to the data PCB 820. The data driving chip 830 is disposed on the data flexible circuit film 810 and controls the data voltage. The fourth side portion 340 of the frame 300 covers the first edge of the data flexible circuit film 810 when the display apparatus 100 is assembled.

In an exemplary embodiment, when a capacity of the common voltage and the driving voltage increases such that the power applying terminal portion 200 alone cannot apply the common voltage and the driving voltage to the display apparatus 1000 sufficiently, the gate and data printed circuit parts 700 and 800 may apply the common voltage and the driving voltage in a similar manner as the power applying terminal portion 200 to accommodate the increased common and driving voltage requirements.

Alternatively, when a size of the display apparatus 1000 is relatively small such that the capacity of the common voltage and the driving voltage decreases, only the gate and data printed circuit parts 700 and 800 may be employed to apply the common voltage and the driving voltage without the power applying terminal portion 200.

The control part 900 is disposed on the display panel 100. As in the illustrated embodiment, the control part 900 is disposed on the display panel 100 along the first direction and extends along the first axis, but the invention is not limited thereto. The control part 900 is electrically connected to the gate and data PCBs 720 and 820 through a control flexible circuit film 910. In one exemplary embodiment, the gate and data PCBs 720 and 820 are disposed to be folded inwardly to the second direction of the display panel 100, such as is illustrated in FIGS. 1 and 4.

The control part 900 controls the gate and date printed circuit parts 700 and 800 according to an external signal, so that the desired images may be displayed in the display panel 100.

The power supply part 600 includes a common voltage supply terminal 610 connected to the common voltage connecting terminal 510 of the frame 300, and a driving voltage supply terminal 620 connected to the driving voltage connecting terminal 520 of the frame 300. In an exemplary embodiment, the cover part 400 of the frame 300 may include a connecting hole connecting the common voltage supply terminal 610 and the driving voltage supply terminal 620 of the power supply part 600 to the common voltage connecting terminal 510 and the driving voltage connecting terminal 520 of the frame 600.

Alternatively, the common voltage supply terminal 610 and the driving voltage supply terminal 620 of the power supply part may be connected to the common voltage connecting terminal 510 and the driving voltage connecting terminal 520 of the frame 300 through an additional wire (not shown) and/or through a soldering of an additional voltage applying element.

In addition, the frame 300 may additionally include an adhesive element 350 (FIG. 4), so that the first, second, third and fourth side portions 310, 320, 330 and 340 of the frame 300 are not separated from each other. The adhesive element 350 is disposed at ends of the side portions that are vertically connected. The adhesive element 350 is configured such that the first and fourth side portions 310 and 340 and the second and third side portions 320 and 330 of the frame 300 can be respectively removably attached. In an exemplary embodiment, the adhesive element 350 has a clip-like shape.

Alternatively, the first, second, third and fourth side portions 310, 320, 330 and 340 of the frame 300 may be fixed to each other through a bolt and nut combination or a rivet combination. Alternatively, a magnet may be disposed at each end portion of the first, second, third and fourth side portions 310, 320, 330 and 340, and the first, second, third and fourth side portions 310, 320, 330 and 340 may be fixed to each other through a magnet combination. Any of a number of fixing elements may be used to combine the side portions to each other, as is suitable for the purpose described herein, such as allowing removable connection.

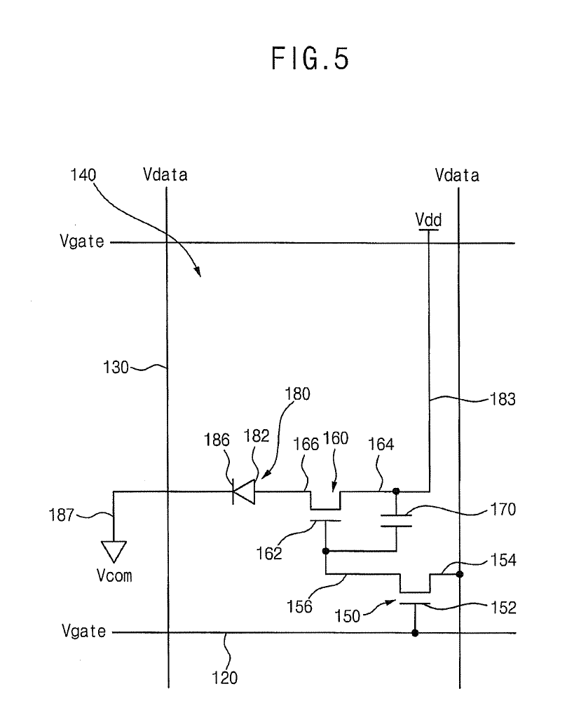

FIG. 5 is a schematic circuit diagram illustrating an exemplary embodiment of a pixel portion of the display panel in FIG. 2.

Referring to FIGS. 2 and 5, when the pixel portion 140 of the display panel 100 receives the gate voltage Vgate from the gate line 120, the data voltage Vdata from the data line 130, the driving voltage Vdd from a driving electrode 183 connected to the first electrode 182, and the common voltage Vcom from a common electrode 187 connected to the second electrode 186, the organic light-emitting element 180 emits light.

A first switching element 150 and a second switching element 160 are formed on the pixel portion 140, also hereinafter referred to as a pixel electrode. The first switching element 150 includes a first gate electrode 152 receiving the gate voltage Vgate, a first source electrode 154 receiving the data voltage Vdata, and a first drain electrode 156 applying a gate signal to the second switching element 160.

The second switching element 160 includes a second gate electrode 162 receiving the gate signal from the first drain electrode 156, a second source electrode receiving the driving voltage Vdd, and a second drain electrode 166 connected to the first electrode 182 of the organic light-emitting element 180 (also shown as EL in FIG. 5). As in the illustrated embodiment, the second electrode 186 of the organic light-emitting element 180 is electrically connected to the common electrode 187. The first and second switching elements 150 and 160 operate as follows. The gate voltage Vgate from the gate line 120 is applied to the first gate electrode 152 of the first switching element 150, to turn on the first switching element 150. The data voltage Vdata from the date line 130 is applied to the first drain electrode 156 through the first source electrode 154. The data voltage Vdata applied to the first drain electrode 156 is applied to the second gate electrode 162 of the second switching element 160.

The second switching element 160 is turned on. The driving voltage Vdd is applied to the second drain electrode 166 from the second source electrode 164 connected to the driving electrode 183. The driving voltage Vdd is applied to the first electrode 182 of the organic light-emitting element 180.

Since the second electrode 186 of the organic light-emitting element 180 is already connected to the common electrode 187, the electric current flows in the organic light-emitting element 180 according to the electric field generated between the driving voltage Vdd and the common voltage Vcom. Therefore, the organic light-emitting element 180 emits light. The organic light-emitting element 180 emits light according to the gate voltage Vgate of the gate line 120, with the driving voltage Vdd and the common voltage Vcom are applied to the driving electrode 183 and the common electrode 187.

Since the data voltage Vdata applied to the second gate electrode 162 of the second switching element 160 may be unstable according to a switching state of the first switching element 150, an additional capacitor 170 may be necessary between the driving voltage Vdd and the first switching element 150, such that a more stable data voltage Vdata may be applied to the second gate electrode 162.

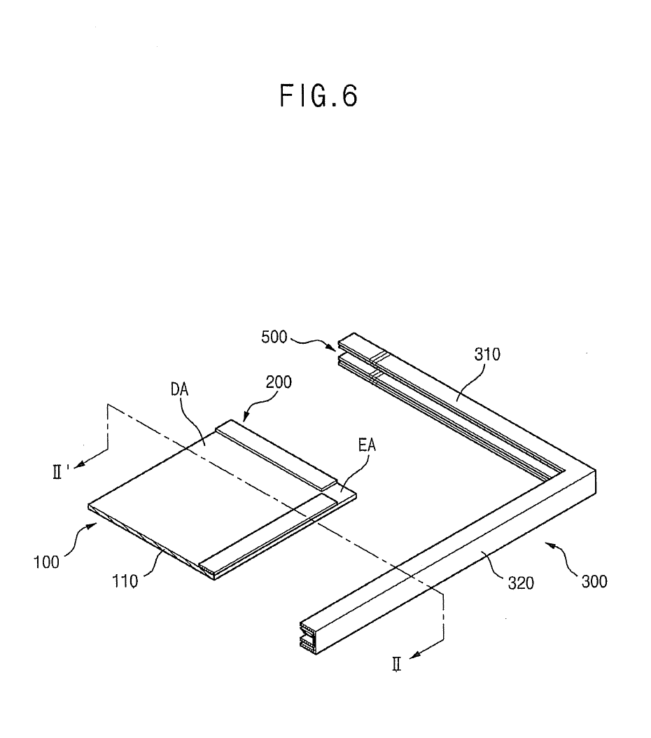

FIG. 6 is an enlarged perspective view illustrating an exemplary embodiment of a portion of the display panel and the frame in FIG. 1. FIG. 7 is a cross-sectional view of a display apparatus including a power connecting terminal portion according to the present invention and taken along line II-II′ in FIG. 6, and FIG. 8 is a cross-sectional view illustrating a combination of the display panel and the frame in FIG. 7.

Referring to FIGS. 6, 7 and 8, the power connecting terminal portion 500 of the frame 300 includes a first combination portion 530 combined with the cover portion 400, a second combination portion 540 extended from a first end of the first combination portion 530, and a third combination portion 550 extended from the cover portion 400 corresponding to a second end of the first combination portion 530. As used herein, “corresponding” is used to indicate corresponding substantially in shape, dimension and/or positional placement.

The first combination portion 530 is fixed to the cover portion 400 and supports the second combination portion 540. A combination groove 410 is formed in the cover portion 400 to accommodate the first combination portion 530. In one exemplary embodiment, the first combination portion 530 may be slid into the combination groove 410 and be fixed to the combination groove 410 of the cover portion 400.

The second combination portion 540 is extended toward the peripheral area EA of the display panel 100. The second combination portion 540 is electrically combined with the power applying terminal portion 200. The second combination portion 540 includes a conductive material. An exemplary embodiment of material that may be used for the second combination portion 540 may include aluminum that has electric conductivity and a light weight.

The second combination portion 540 has a trapezoidal shape cross section as shown in FIGS. 7 and 8, for being easily combined with the display panel 100. In the illustrated embodiment, a distal end portion of the second combination portion 540 may have an inclined shape in a direction towards the second end of the first combination portion 530. Alternatively, the end portion of the second combination portion 540 may have any of a number of shapes, such as a rounded shape, so long as the second combination portion 540 is configured to be relatively easily combined with the display panel 100.

The first combination portion 530 may include the same material as the second combination portion 540, such as to completely support the second combination portion 540. Alternatively, the first combination portion 530 may include a different material, such as an insulation resin material, such that the first combination portion 530 is fixed to the cover portion 400 and supports the second combination portion 540.

The third combination portion 550 is extended substantially parallel with the first combination portion 530. As in the illustrated embodiment, the third combination portion 550 (e.g., an upper surface) is combined with a rear surface of the power applying terminal portion 200 of the insulating substrate 110. The third combination portion 550 contacts the rear surface of the power applying terminal portion 200 and fixes the display panel 100 in combination with the second combination portion 540. In an exemplary embodiment, a distal end portion of the third combination portion 550 may have an inclined shape in a direction towards the first end of the first combination portion 530 and/or may have the rounded shape as is also available for the second combination portion 540. The distal ends of the second and third combination portions 540 and 550 may have similar profiles or may have differently shaped ends.

Referring to FIG. 7, a distance D between the second and third combination portions 540 and 550 is smaller than a thickness t1 of the display panel including the power applying terminal portion 200. The distance D may be smaller than thickness t1 by about 0.02 millimeter (mm) to about 0.08 millimeter (mm). In one exemplary embodiment, the distance D is smaller than the thickness t1 by about 0.05 mm. In the illustrated embodiment, the thickness t1 of the display panel 100 is about 1.4 mm and a thickness t2 of the frame 300 is about 2.0 mm. Essentially, the display panel 100 including the power applying terminal portion 200 may be combined with the frame 300 using an interference fit.

In an exemplary embodiment, the third combination portion 550 may include the same insulation material as the cover portion 400. Thus, an interfering electric field generated in the display panel 100 may be avoided, such that defective display images may be reduced.

In one exemplary embodiment, when the third combination portion 550 includes the conductive material, the insulating substrate 110 of the display panel 100 acts as a dielectric material to electrically charge the second and third combination portions 540 and 550. The electric charges affect the pixel portions 140, so that defective images may be displayed. In order to solve the above-mentioned problem, the third combination portion 550 includes the insulating material, to avoid displaying defective display images.

As in the illustrated embodiment, the power applying terminal portion 200 of the display panel 100 is electrically combined with the second combination portion 540 of the power connecting terminal portion 500. An area of the power connecting terminal portion 500 is relative larger than that of conventional flexible circuit films, such that a resistance generated in the display panel 100 may be decreased. Advantageously, power consumption may be decreased.

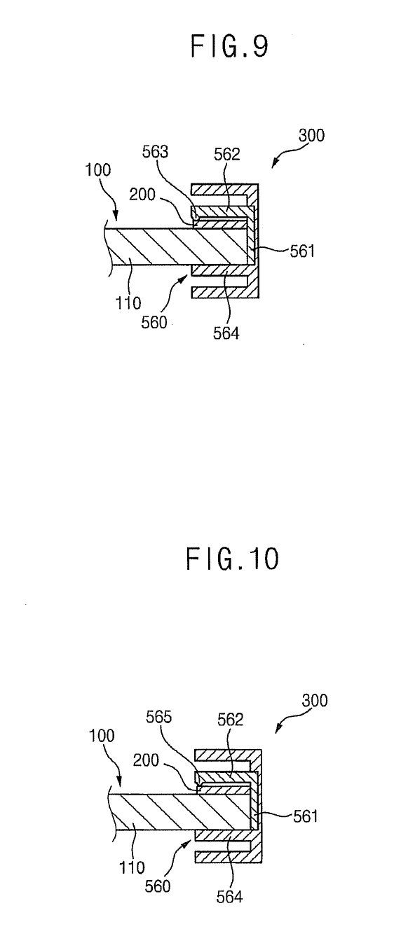

FIG. 9 is a cross-sectional view of another exemplary embodiment of a display apparatus including a power connecting terminal portion according to the present invention taken along line II-II′ in FIG. 6.

Referring to FIGS. 6 and 9, a power connecting terminal portion 560 of the frame 300 includes a first combination portion 561 combined with the cover portion 400, a second combination portion 562 extended from a first end of the first combination portion 561, and a third combination portion 564 extended from the cover portion 400 corresponding to a second end of the first combination portion 561.

The second combination portion 562 of the power connecting terminal portion 560 is protruded toward the third combination portion 564. The second combination portion 562 includes a protrusion portion 563 for contacting and pressing the power applying terminal portion 200.

The protrusion portion 563 is electrically connected to the power applying terminal portion 200. The protrusion portion 563 is formed on the frame 300 in a direction along a longitudinal direction of the second combination portion 562. A cross-sectional shape of the protrusion portion 563 may include a rounded shape. Advantageously, the display panel 100 including the power applying terminal portion 200 may be relatively easily inserted into the power connecting terminal portion 560. Alternatively, a plurality of protrusions may be formed along the longitudinal direction of the second combination portion 562. The protrusion portion may have a half-circular shape.

The protrusion portion 563 is formed at a distal edge portion of the second combination portion 562 and protrudes towards the power applying terminal portion 200 from a lower surface of the second combination portion 562. Even though the power applying terminal portion 200 is not inserted towards an inner end of the power connecting terminal portion 560, the power applying terminal portion 200 may be electrically connected to the power connecting terminal portion 560 through the protrusion portion 563. Alternatively, the protrusion portion 563 may be formed at the edge portion or a center portion of the second combination portion 562, such that the power applying terminal portion 200 and the power connecting terminal portion 560 are electrically connected to each other.

In an exemplary embodiment, the protrusion portion 563 may be manufactured by changing a mold for manufacturing the second combination portion 562. Alternatively, the protrusion portion 563 may be manufactured such as using a punching process including a press or a compression machine after manufacturing the second combination portion 562.

Since the second combination portion 562 includes the protrusion portion 563, the common voltage and the driving voltage may be stably applied to the power applying terminal portion 200.

FIG. 10 is a cross-sectional view of another exemplary embodiment of a display apparatus including a power connecting terminal portion according to the present invention taken along line II-II′ in FIG. 6.

The power connecting terminal portion of FIG. 10 is substantially the same as in FIG. 9 except for the protrusion portion's shape. Thus, the same reference numerals will be used to refer to the same or like parts as those described in FIG. 9 and any further repetitive explanation concerning the above elements will be omitted.

Referring to FIGS. 6 and 10, a cross-sectional shape of a protrusion portion 565 that is formed at the second combination portion 562 of the power connecting terminal portion 560 has a substantially triangular shape (e.g., cross section).

The protrusion portion 565 is formed and extends along the longitudinal direction of the second combination portion 562. Alternatively, a plurality of protrusion portions 565 having a triangular pyramid shape may be formed at the second combination portion 562 along a longitudinal direction thereof.

Since the protrusion portion 565 includes a sharp distal end and the sharp end contacts the power applying terminal portion 200 in a relatively small point or area, after the display panel 100 including the power applying terminal portion 200 is inserted into the power connecting terminal portion 560, such as by an external force, separation of the inserted display panel 100 from the power connecting terminal portion 560 is reduced or effectively prevented. In the illustrated embodiment, the protrusion portion 565 is configured to have a sharp peak inclined toward a first combination portion 561, so that the display panel 100 may be fixed more strongly.

In an alternative exemplary embodiment, the power applying terminal portion 200 may include a combination portion combined with a distal end portion of the protrusion portion 565. The combination of the combination portion of the power applying terminal portion 200 with the protrusion portion 565 may also be referred to as a hook combination. Alternatively, the distal end portion of the protrusion portion 565 may have a substantially flat rectangular shape, for enlarging a contact area with the power applying terminal portion 200.

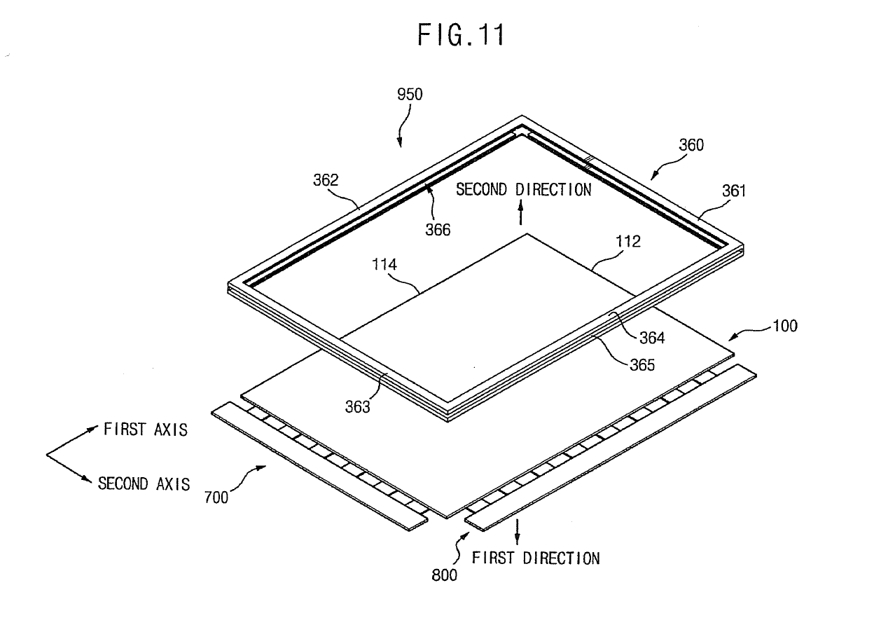

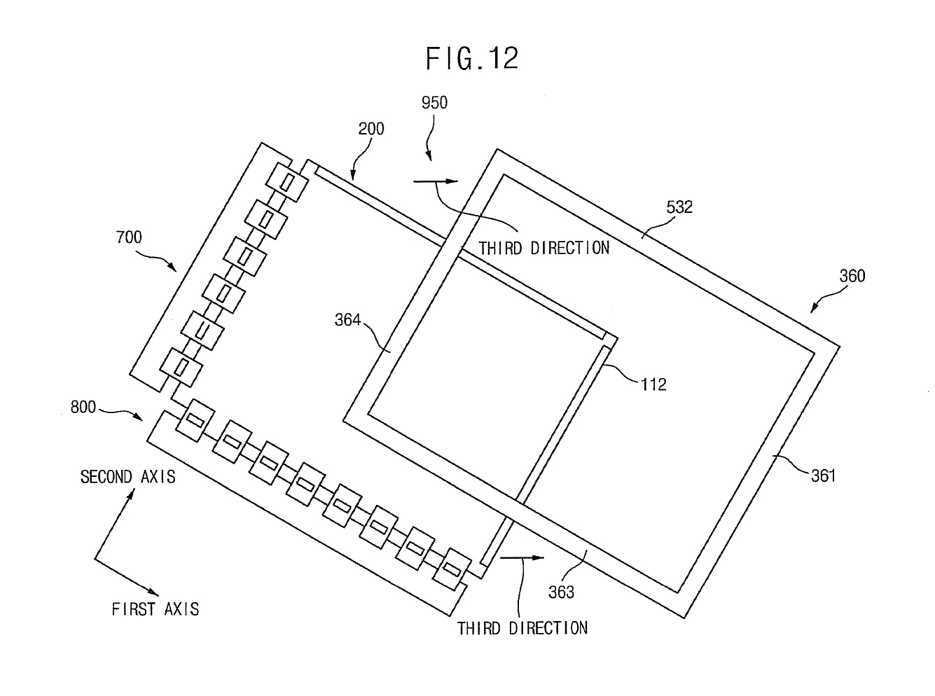

FIG. 11 is a perspective view illustrating another exemplary embodiment of a display apparatus according to the present invention, and FIG. 12 is a plan view illustrating an exemplary embodiment of an assembly of the display apparatus and a frame in FIG. 11.

The display apparatus of FIGS. 11 and 12 is same as in FIGS. 1 to 10 except for a frame's shape. Thus, the same reference numerals will be used to refer to the same or like parts as those described in FIGS. 1 to 10 and any further repetitive explanation concerning the above elements will be omitted.

Referring to FIGS. 11 and 12, the display apparatus 950 includes a frame 360. The frame 360 includes a rectangular frame shape having first, second, third and fourth side portions 361, 362, 363 and 364. A penetration groove 365 is formed in the third and fourth side portions 363 and 364 of the frame 360, for fixing the display panel 100. As in the illustrated embodiment, the frame 360 may be formed as a continuous member (e.g., integral piece) and reducing the number of separate parts of the frame. Through the penetration groove 365, the display panel 100 can still be combined with the closed and continuous frame 360.

An exemplary embodiment of a combining of the display panel 100 and the frame 360 including inserting the display panel 100 into the frame 360 through the penetration groove 365 of the frame 360 is as follows. The frame 360 is disposed substantially parallel with the display panel 100. An edge portion at which the first and second edge portions 112 and 114 of the display panel 100 meet each other is disposed to correspond to an edge portion at which the third and fourth side portions 363 and 364 of the frame 360 meet each other.

The display panel 100 is inserted into the frame 360 through the penetration groove 365 along a third direction as indicated by the arrows. The first and second edge portions 112 and 114 led by the corner formed by the first and second edge portions 112 and 114 are inserted into the penetration groove 365 of the frame 300. The third direction is substantially parallel with the first axis and is substantially perpendicular to the first and second directions.

The power applying terminal portion 200 disposed at the first and second edge portions 112 and 114 is inserted into and fixed to a power connecting terminal portion 366 disposed in the first and second side portions 361 and 362 of the frame 360. The gate printed circuit part 700 and the date printed circuit part 800 are disposed to be inwardly folded or bent in the first direction of the display panel 100. The first direction is opposite to the second direction toward which the display panel displays images.

Advantageously, the display panel 100 may be fixed to an inner space of the frame 360 having the rectangular frame shape, so that the power applying terminal portion 200 may be electrically connected to the power connecting terminal portion 366.

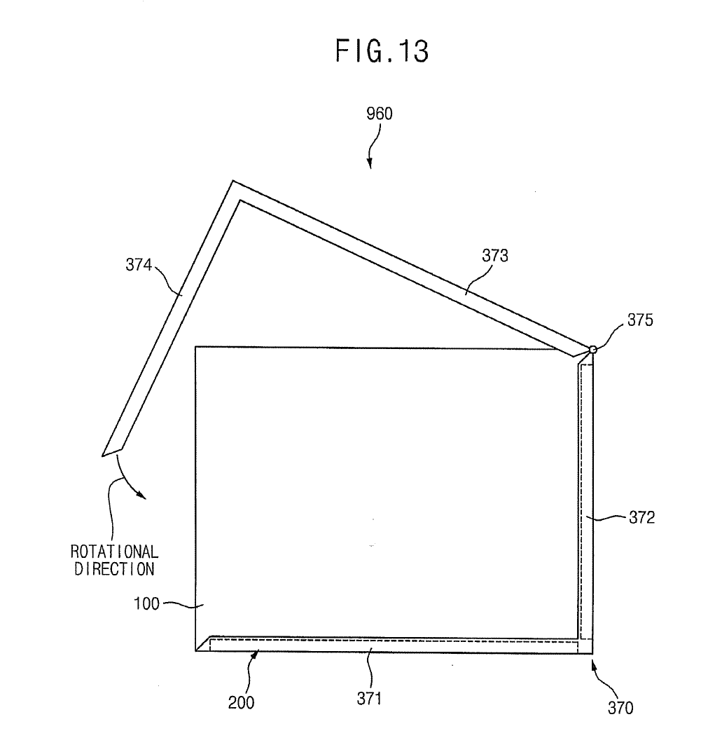

FIG. 13 is a perspective view illustrating another exemplary embodiment of a display apparatus according to the present invention.

The display apparatus of FIG. 13 is substantially the same as in FIGS. 1 to 10 except for a frame's structure. Thus, the same reference numerals will be used to refer to the same or like parts as those described in FIGS. 1 to 10 and any further repetitive explanation concerning the above elements will be omitted.

Referring to FIG. 13, the display apparatus 960 includes a frame 370. The frame 370 includes first, second, third and fourth side portions 371, 372, 373 and 374. The first side portion 371 may be separated from the fourth side portion 374. A hinge element 375 is disposed between the second and third side portions 372 and 373. The first and second side portions 371 and 372 are integrally formed with each other (e.g., as a single continuous piece), and the third and fourth side portions 373 and 374 are integrally formed with each other.

As in the illustrated embodiment, the frame 370 is configured such that the first and second side portions 371 and 372, and the third and fourth side portions 373 and 374 may relatively rotate with respect to the hinge element 375.

An exemplary embodiment of a combining of the display panel 100 with the frame 370 is as follows. The first and second edge portions 112 and 114 of the display panel 100 including the power applying terminal 200 are inserted and fixed to the first and second side portions 371 and 372 of the frame 370 including a power connecting terminal portion disposed therein.

The third and fourth side portions 373 and 374 of the frame 370 are rotated, so that an end portion of the fourth side portion 374 that is opposite to the third side portion 373 is combined with an end portion of the first side portion 371 that is opposite to the second side portion 372. The end portion of the fourth side portion 374 is combined with the end portion of the first side portion 371, such as through an additional fixing element, or through a magnet that is disposed at the end portions of the first and fourth side portions 371 and 374.

The first, second, third and fourth side portions 371, 372, 373 and 374 of the frame 370 are treated as one body through the hinge element 375 (e.g., integrally formed), so that the frame 370 may be easily processed and handled.

As in the illustrated embodiments, the driving power is supplied to the driving electrode and the common electrode through the power connecting terminal portion formed on the first and second side portions of the frame, instead of through the flexible circuit film and the printed circuit film that are formed at the first and second end portions of the display panel, so that costs for manufacturing the display panel may be decreased.

In addition, the flexible circuit film and the printed circuit film that may be conventionally used may be eliminated, so that the structure of the display panel may be simplified and a number of parts reduced. Advantageously, a process for manufacturing the display apparatus may be simplified and a number of processing steps reduced, so that process time for manufacturing the display apparatus may be decreased.

Having described the exemplary embodiments of the present invention and its advantages, it is noted that various changes, substitutions and alterations can be made herein without departing from the spirit and scope of the invention as defined by appended claims.

What is claimed is:

1. A display apparatus comprising:
a display panel including a display area and a peripheral area;
a power applying terminal portion disposed in the peripheral area of the display panel;
a frame including a cover portion covering an edge of the display panel, and a power connecting terminal portion disposed on an inner surface of the cover portion and electrically connected to the power applying terminal portion; and
a power supply part disposed on the frame and supplying a driving power to the power connecting terminal portion.

2. The display apparatus of claim 1, wherein the cover portion comprises an insulation material.

3. The display apparatus of claim 2, wherein a plurality of pixel portions is disposed in the display area of the display panel, each of pixel portions comprising:
a first switching element electrically connected to a gate line and a data line;
a second switching element electrically connected to the first switching element and a driving electrode; and
an organic emitting element electrically connected to the second switching element and a common electrode.

4. The display apparatus of claim 3, wherein the power applying terminal portion comprises:
a common voltage applying terminal disposed at a first edge portion of an insulating substrate of the display panel and applying a common voltage of the driving power to the common electrode; and
a driving voltage applying terminal disposed at a second edge portion of the insulating substrate perpendicular to the first edge portion and applying a driving voltage of the driving power to the driving electrode.

5. The display apparatus of claim 4, wherein the power connecting terminal portion comprises:
a first combination portion combined with the cover portion;
a second combination portion extended from a first end of the first combination portion towards the peripheral area of the display panel and electrically combined with the power applying terminal portion; and
a third combination portion extended from the cover portion corresponding to a second end of the first combination portion and fixing the display panel with the second combination portion.

6. The display apparatus of claim 5, wherein a distance in a first direction between the second and third combination portions is smaller than a thickness in the first direction of the display panel including the power applying terminal portion by about 0.02 millimeter (mm) to about 0.08 millimeter (mm).

7. The display apparatus of claim 6, wherein the second combination portion has a trapezoidal shape.

8. The display apparatus of claim 6, wherein the second combination portion comprises a protrusion portion disposed at a distal end of the second combination portion, protruding toward the third combination portion, and contacting the power applying terminal portion.

9. The display apparatus of claim 8, wherein the protrusion portion has a rounded shape.

10. The display apparatus of claim 8, wherein the protrusion portion has a triangular shape.

11. The display apparatus of claim 4, wherein the power connecting terminal portion comprises:
a common voltage connecting terminal combined with the common voltage applying terminal; and
a driving voltage connecting terminal combined with the driving voltage applying terminal.

12. The display apparatus of claim 11, wherein the frame comprises:
a first side portion, the common voltage connecting terminal disposed on the first side portion;
a second side portion adjacent to and substantially perpendicular to the first side portion, the driving voltage connecting terminal disposed on the second side portion;
a third side portion facing the first side portion and being removably connected to the second side portion; and
a fourth side portion facing the second side portion and being removably connected to the first side portion.

13. The display apparatus of claim 12, the display panel further including:
a gate printed circuit part corresponding to the third side portion of the frame and being connected to a third edge portion of the insulating substrate that faces the first edge portion of the insulating substrate;
a data printed circuit part corresponding to the fourth side portion of the frame and being connected to a fourth edge portion of the insulating substrate that faces the second edge portion of the insulating substrate; and
a control part disposed in the display area of the display panel and connected to the gate printed circuit part and the data printed circuit part.

14. The display apparatus of claim 13, wherein the first and second side portions of the frame are configured to be removably combined with the third and fourth side portions of the frame, respectively.

15. The display apparatus of claim 14, wherein a fixing member is disposed covering adjacent ends of the first and fourth side portions, and the second and third side portions.

16. The display apparatus of claim 14, wherein the second and third side portions of the frame are configured to be separated by a hinge member connected to adjacent ends of the second and third side portions.

17. The display apparatus of claim 13, wherein the frame further includes a penetration groove disposed in the third and fourth side portions, and the display panel passes through the penetrating groove and is combined with the power connecting terminal portion.

18. The display apparatus of claim 13, wherein the power supply part corresponds to a corner of the frame where the first and second side portions of the frame are adjacent to each other.

19. A method of forming a display apparatus, the method comprising:
forming a display panel including a display area and a peripheral area;
disposing a power applying terminal portion on the peripheral area of the display panel;
forming a frame including a cover portion and a power connecting terminal portion disposed on an inner surface of the cover;
disposing a power supply part on the frame and supplying a driving power to the power connecting terminal portion; and
combining the display panel and the frame, and electrically connecting the power applying terminal portion on the display panel and the power connecting terminal portion of the frame, the cover covering an outer edge of the display panel.
